(19) United States
(12) Patent Application Publication
(10) Pub. No.: US 2023/0155797 A1
(43) Pub. Date: May 18, 2023

(54) METHOD FOR IDENTIFYING RADIO COMMUNICATION SERVICES

(71) Applicant: ZTE CORPORATION, Shenzhen (CN)

(72) Inventors: Feng XIE, Shenzhen (CN); Shuqiang XIA, Shenzhen (CN); Wei LUO, Shenzhen (CN)

(73) Assignee: ZTE CORPORATION, Shenzhen (CN)

(21) Appl. No.: 18/146,005

(22) Filed: Dec. 23, 2022

Related U.S. Application Data
(63) Continuation of application No. PCT/CN2020/097931, filed on Jun. 24, 2020.

(51) Int. Cl. H04L 5/00; H04W 8/00; H04W 72/20

(52) U.S. Cl. CPC H04L 5/0091; H04L 5/0048; H04W 8/005; H04W 72/20

(57) ABSTRACT

Presented are systems and methods for identifying radio communication services. A wireless communication device may determine a transmission control indication state identifier (TCI) according to at least one transmission from a wireless communication node. The wireless communication device may determine an identity of a domain. The wireless communication device may identify a transmission control indication state within the domain according to the TCI and the identity.

### CROSS-REFERENCE TO RELATED APPLICATION

This application claims the benefit of priority under 35 U.S.C. § 120 as a continuation of PCT Patent Application No. PCT/CN2020/097931, filed on Jun. 24, 2020, the disclosure of which is incorporated herein by reference in its entirety.

### TECHNICAL FIELD

The disclosure relates generally to wireless communications, including but not limited to systems and methods for identifying radio communication services.

### BACKGROUND

The standardization organization Third Generation Partnership Project (3GPP) is in the process of specifying a new Radio Interface called 5G New Radio (5G NR) as well as a Next Generation Packet Core Network (NG-CN or NGC). The 3GPP is constantly considering the specification requirements for the next generation of wireless communication, such as B5G and 6G. In order to enable different data services and requirements, current definition(s) of components of a wireless communication network may be unsuitable.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may determine a transmission control indication state identifier (TCI) according to at least one transmission from a wireless communication node. The wireless communication device may determine an identity of a domain. The wireless communication device may identify a transmission control indication state within the domain. The wireless communication device may identify the transmission control indication state according to the TCI and the identity.

In some embodiments, the at least one transmission may comprise at least one of a system information block (SIB), a synchronization signal, a physical broadcast channel (PBCH), or a reference signal (RS). In some embodiments, the wireless communication device may determine the identity of the domain according to at least one of the synchronization signal or the SIB. In some embodiments, the wireless communication device may determine the TCI using the identity of the domain in the SIB and additional information in the SIB. In some embodiments, the wireless communication device may determine the TCI using the identity of the domain in the SIB and a synchronization signal block index (SSBI) in the PBCH. In some embodiments, the wireless communication device may determine the TCI using the identity of the domain and a transmission control indication state group identity (TCGI) in the SIB, and a synchronization signal block index (SSBI) in the PBCH.

In some embodiments, the wireless communication device may determine the TCI using the identity of the domain and a CSI-RS resource index (CRI) in the SIB. The CRI may be selected according to the CSI-RS. In some embodiments, the wireless communication device may determine the TCI using the identity of the domain and TCI information in the SIB. The TCI information may be selected according to the CSI-RS. In some embodiments, the wireless communication device may determine the TCI using the identity of the domain, a transmission control indication state group identity (TCGI) and TCI information in the SIB. The TCI information may be selected according to the CSI-RS. In some embodiments, the wireless communication device may determine the TCI using the identity of the domain, a transmission control indication state group identity (TCGI) and a CSI-RS resource index (CRI) in the SIB. The CRI may be selected according to the CSI-RS.

In some embodiments, the wireless communication device may determine the TCI using the identity of the domain and a CSI-RS resource index (CRI) in the SIB, and a synchronization signal block index (SSBI) in the PBCH. The CRI may be selected according to the CSI-RS. In some embodiments, the wireless communication device may determine the TCI using information in the SIB. In some embodiments, the wireless communication device may determine the TCI using a transmission control indication state group identity (TCGI) in the SIB, and a synchronization signal block index (SSBI) in the PBCH. In some embodiments, the wireless communication device may determine the TCI using a transmission control indication state group identity (TCGI) and a CSI-RS resource index (CRI) in the SIB. The CRI may be selected according to the CSI-RS.

In some embodiments, the wireless communication device may determine the TCI using a transmission control indication state group identity (TCGI) and TCI information in the SIB. The TCI information may be selected according to the CSI-RS. In some embodiments, the wireless communication device may determine the TCI using a transmission control indication state group identity (TCGI) and a CSI-RS resource index (CRI) in the SIB, and a synchronization signal block index (SSBI) in the PBCH. The CRI may be selected according to the CSI-RS. In some embodiments, the wireless communication device may identify a location using the TCI. In some embodiments, the wireless communication device may report the TCI with at least one of: a measurement, a radio link failure, a beam failure, or a minimization of drive test (MDT).

At least one aspect is directed to a system, method, apparatus, or a computer-readable medium. A wireless communication node may send at least one transmission to a wireless communication device to determine a transmission control indication state identifier (TCI). The the wireless communication device may be caused to determine an identity of a domain. The wireless communication device may be caused to identify a transmission control indication state within the domain according to the TCI and the identity.

In some embodiments, the at least one transmission may comprise at least one of a system information block (SIB), a synchronization signal, a physical broadcast channel (PBCH), or a reference signal (RS). In some embodiments, the wireless communication device may be caused to determine the identity of the domain according to at least one of the synchronization signal or the SIB. In some embodiments, the wireless communication device may be caused to determine the TCI using the identity of the domain in the SIB and additional information in the SIB. In some embodiments, the wireless communication device may be caused to determine the TCI using the identity of the domain in the SIB and a synchronization signal block index (SSBI) in the PBCH. In some embodiments, the wireless communication device may be caused to determine the TCI using the identity of the domain and a transmission control indication state group identity (TCGI) in the SIB, and a synchronization signal block index (SSBI) in the PBCH.

In some embodiments, the wireless communication device may be caused to determine the TCI using the identity of the domain and a CSI-RS resource index (CRI) in the SIB. The CRI may be selected according to the CSI-RS. In some embodiments, the wireless communication device may be caused to determine the TCI using the identity of the domain and TCI information in the SIB. The TCI information may be selected according to the CSI-RS. In some embodiments, the wireless communication device may be caused to determine the TCI using the identity of the domain, a transmission control indication state group identity (TCGI) and TCI information in the SIB. The TCI information may be selected according to the CSI-RS. In some embodiments, the wireless communication device may be caused to determine the TCI using the identity of the domain, a transmission control indication state group identity (TCGI) and a CSI-RS resource index (CRI) in the SIB. The CRI may be selected according to the CSI-RS.

In some embodiments, the wireless communication device may be caused to determine the TCI using the identity of the domain and a CSI-RS resource index (CRI) in the SIB, and a synchronization signal block index (SSBI) in the PBCH. The CRI may be selected according to the CSI-RS. In some embodiments, the wireless communication device may be caused to determine the TCI using information in the SIB. In some embodiments, the wireless communication device may be caused to determine the TCI using a transmission control indication state group identity (TCGI) in the SIB, and a synchronization signal block index (SSBI) in the PBCH. In some embodiments, the wireless communication device may be caused to determine the TCI using a transmission control indication state group identity (TCGI) and a CSI-RS resource index (CRI) in the SIB. The CRI may be selected according to the CSI-RS.

In some embodiments, the wireless communication device may be caused to determine the TCI using a transmission control indication state group identity (TCGI) and TCI information in the SIB. The TCI information may be selected according to the CSI-RS. In some embodiments, the wireless communication device may be caused to determine the TCI using a transmission control indication state group identity (TCGI) and a CSI-RS resource index (CRI) in the SIB, and a synchronization signal block index (SSBI) in the PBCH. The CRI may be selected according to the CSI-RS. In some embodiments, the wireless communication device may be caused to identify a location using the TCI. In some embodiments, the wireless communication device may be caused to report the TCI with at least one of: a measurement, a radio link failure, a beam failure, or a minimization of drive test (MDT).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example wireless communication system, in accordance with some embodiments of the present disclosure;

FIG. 4 illustrates example approaches for acquiring identifiers of domains, in accordance with some embodiments of the present disclosure;

FIG. 5 illustrates an example system for identifying radio communication services, in accordance with some embodiments of the present disclosure;

FIGS. 6-18 illustrate various approaches for establishing or determining embodiments of an identifier for identifying radio communication services, in accordance with some embodiments of the present disclosure; and

FIG. 19 illustrates a flow diagram of an example method of identifying radio communication services, in accordance with an embodiment of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The following acronyms are used throughout the present disclosure:

| Acronym | Full Name |
|---|---|
| 3GPP | 3rd Generation Partnership Project |
| 5G | 5th Generation Mobile Networks |
| 5G-AN | 5G Access Network |
| 5G gNB | Next Generation NodeB |
| 5G-GUTI 5G- | Globally Unique Temporary UE Identify |
| AF | Application Function |
| AMF | Access and Mobility Management Function |
| AN | Access Network |
| ARP | Allocation and Retention Priority |
| CA | Carrier Aggregation |
| CI | Layer 3 Cell Identity |
| CM | Connected Mode |
| CMR | Channel Measurement Resource |
| CSI | Channel State Information |
| CQI | Channel Quality Indicator |
| CSI-RS | Channel State Information Reference Signal |
| CRI | CSI-RS Resource Indicator |
| CSS | Common Search Space |
| DAI | Downlink Assignment Index |
| DCI | Downlink Control Information |
| DL | Down Link or Downlink |
| DN | Data Network |
| DNN | Data Network Name |
| ETSI | European Telecommunications Standards |
| | Institute |
| FR | Frequency range |
| GBR | Guaranteed Bit Rate |
| GFBR | Guaranteed Flow Bit Rate |
| HARQ | Hybrid Automatic Repeat Request |
| ID | Identity |
| L1 | Layer 1 |
| L3 | Layer 3 |
| MAC-CE | Medium Access Control (MAC) Control |
| | Element (CE) |
| MCS | Modulation and Coding Scheme |
| MBR | Maximum Bit Rate |
| MFBR | Maximum Flow Bit Rate |
| NAS | Non-Access Stratum |
| NF | Network Function |
| NG-RAN | Next Generation Node Radio Access Node |
| NR | Next Generation RAN |
| NZP | Non-Zero Power |
| OFDM | Orthogonal Frequency-Division Multiplexing |
| OFDMA | Orthogonal Frequency-Division Multiple |
| | Access |
| PCF | Policy Control Function |
| PCI | Physical Cell Identity |
| PDCCH | Physical Downlink Control Channel |
| PDSCH | Physical Downlink Shared Channel |
| PDU | Packet Data Unit |
| PHY | Physical layer |
| PUCCH | Physical uplink control channel |
| PMI | Precoding Matrix Indicator |
| PPCH | Physical Broadcast Channel |
| PRI | PUCCH resource indicator |
| QoS | Quality of Service |
| QCL | Quasi-co-location |
| RAN | Radio Access Network |
| RAN CP | Radio Access Network Control Plane |
| RAT | Radio Access Technology |
| RBG | Resource Block Group |
| RRC | Radio Resource Control |
| RSRP | Reference Signal Received Power |
| RSRQ | Reference Signal Received Quality |
| RV | Redundant Version |
| SM NAS | Session Management Non Access Stratum |
| SMF | Session Management Function |
| SRS | Sounding Reference Signal |
| SS | Synchronization Signal |
| SSB | SS/PBCH Block |
| SSBI | SSB index |
| TB | Transport Block |
| TC | Transmission Configuration |
| TCI | Transmission Configuration Indicator |
| TRP | Transmission/Reception Point |
| UCI | Uplink Control Information |
| UDM | Unified Data Management |
| UDR | Unified Data Repository |
| UE | User Equipment |
| UL | Up Link or Uplink |
| UPF | User Plane Function |
| USS | UE Specific Search Space |

### 1. Mobile Communication Technology and Environment

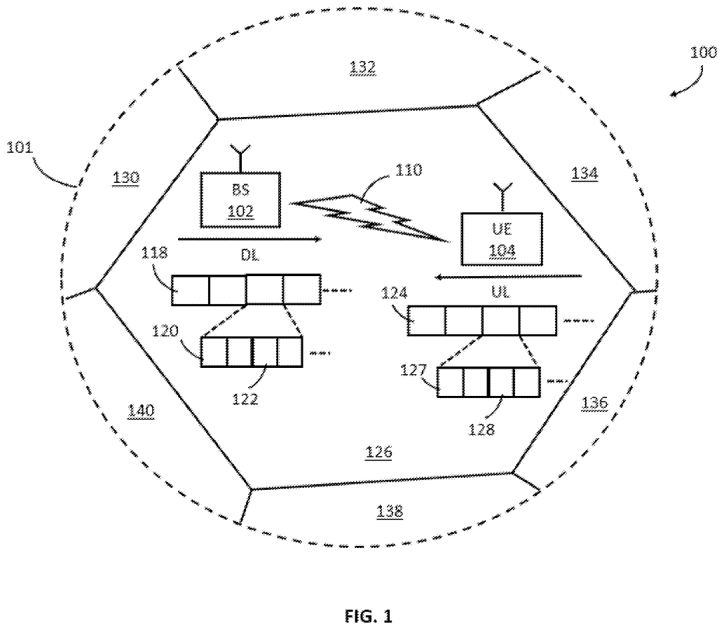

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

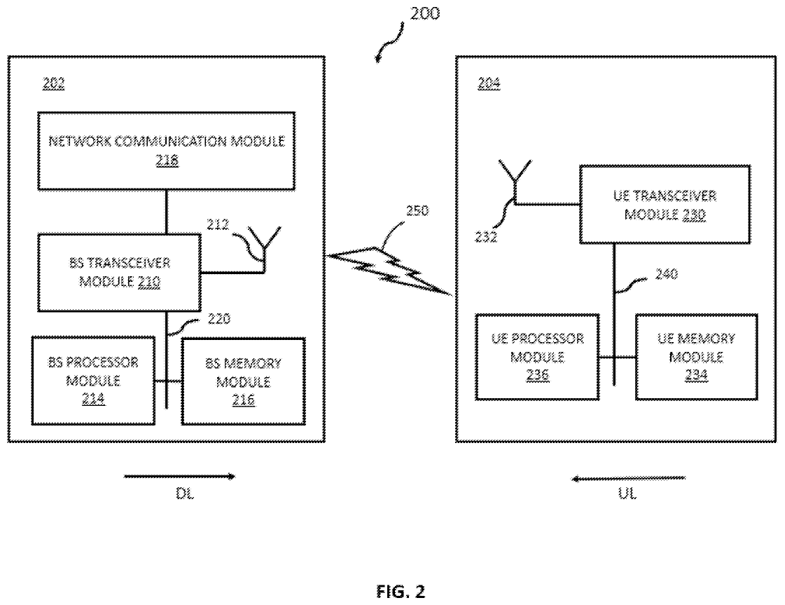

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Identifying Radio Communication Services

In a wireless communication system, a receiving device (e.g., a wireless communication node or wireless communication device, such as a UE, a base station, or a served node) may identify, discover, recognize, and/or determine a radio communication service by utilizing an identity of a domain (e.g., a cell ID, a service area ID, a PLMN ID and/or other identifiers). However, certain identifiers (e.g., a cell ID, a PCI, a CI, and/or other identifiers) and/or domain definitions (e.g., a cell, a service area, a PLMN, and/or other definitions) may be unsuitable to meet the demands of evolving wireless communication systems (e.g., a radio communication system and/or other wireless communication systems).

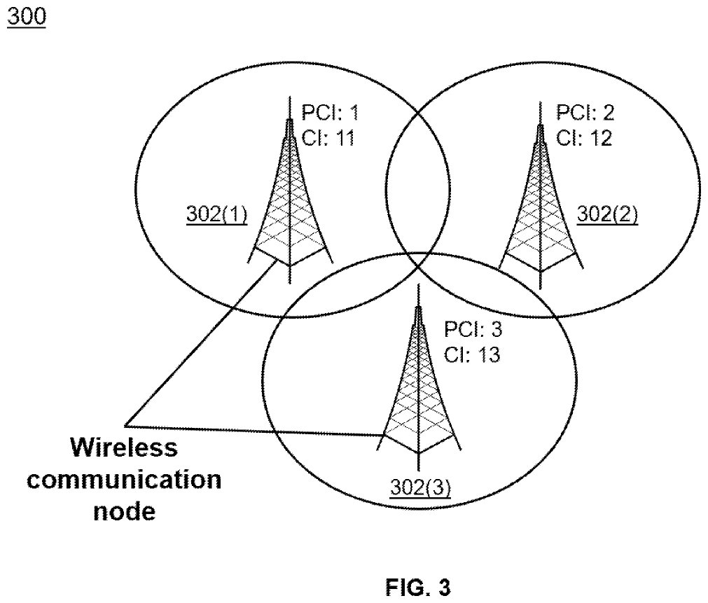

Referring now to FIG. 3, depicted is an example wireless communication system 300, such as a cellular communication system. In the cellular communication system, one or more identifiers may be utilized for identification of a radio communication service, such as a physical cell identity (PCI) and/or a Layer-3 cell identity (CI). For example, the PCI (or Layer-1 cell identity), the CI and/or other identifiers may be utilized for service identification in a wireless communication node(s) 302 (e.g., a ground terminal, a base station, a gNB, an eNB, or a serving node) and/or a cell.

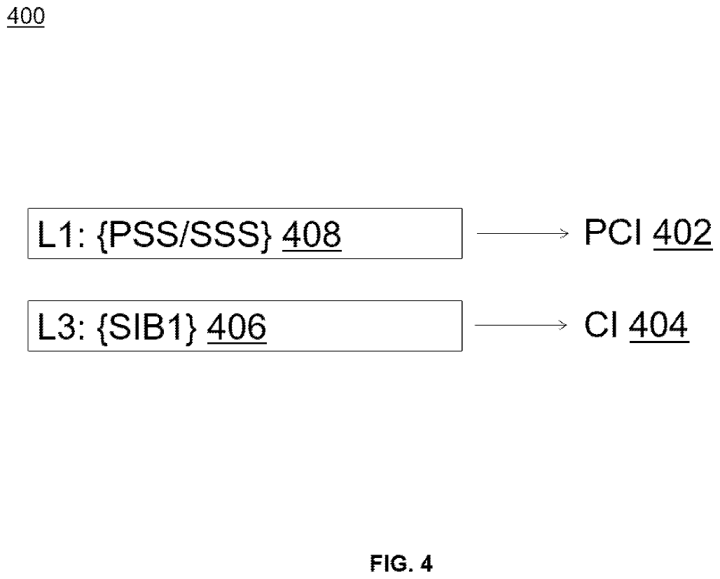

As illustrated in FIG. 4, a wireless communication device (e.g., a UE or a served node) may determine, obtain and/or receive the identifier (e.g., the PCI 402, the CI 404, and/or other identifiers) according to (e.g., using contents/information in) at least one transmission (e.g., a synchronization signal 408, a system information block (SIB) 406, a physical broadcast channel (PBCH), a reference signal, and/or other signals or transmissions) from the wireless communication node(s) 302. For example, a wireless communication device may obtain and/or receive the PCI 402 according to a synchronization signal 408 sent and/or transmitted by the wireless communication node(s) 302. The PCI 402 value(s) may range from 0 to 503 in Long Term Evolution (LTE) systems, and from 0 to 1007 in New Radio (NR) systems. In another example, the wireless communication device may determine, obtain and/or receive the CI 404 according to a Layer-3 SIB1 406 broadcast or transmission from the wireless communication node(s) 302. The CI 404 may be a 36-bits identifier (or an identifier of some other defined length) that can be utilized for cell identification, e.g., within a public land mobile network (PLMN).

From a wireless communication system perspective, a cell can refer to a wireless coverage region, and may relate to a type of entity on the network or within the wireless communication node(s) 302. Radio network functions (e.g., connection setup, mobility management, paging, and/or other functions) may be based on the service(s) of the cell. The wireless communication device(s) may identify, detect, and/or perceive the cell as the minimum radio network function unit.

Technical fields relating to radio communication systems may show an increased interest for massive antenna applications and user-centric networking. A desire to distinguish the different antennas and/or beams in massive antenna applications/technologies (e.g. beam forming) may lead to a demand for higher resolution radio network functions. User-centric networking may provide an enhanced user experience, by for example, enabling seamless mobility management. User-centric networking applications may utilize and/or require lower resolution radio network functions. The cell as the minimum radio network function unit may be unable to meet the different or contradictory demands for enabling massive antenna applications/technologies and user-centric networking applications.

The systems and methods presented herein include a novel method for identification of radio communication service. A receiving device (or served entity) can determine and/or utilize a novel identifier (e.g., a transmission control indication state identifier (TCI) and/or other identifiers) to identify a transmission control indication state comprising one or more types of information (e.g., information related to beam, beam forming, antenna, signal reception attributes and/or other types of information). A receiving device may receive and/or obtain at least one transmission (e.g., a SIB, a synchronization signal, a PBCH, a reference signal, a channel state information reference signal (CSI-RS), a physical channel resource configuration, and/or other transmissions or signals) from a transmitting device (e.g., a serving entity or a wireless communication node 302, such as a base station). The at least one transmission may be related to, associated with, and/or linked to the novel identifier, such as the TCI, for instance by including or having information that can be used to form or establish the novel identifier. The receiving device may determine, generate, and/or establish the identifier (e.g. the TCI and/or other identifier(s)) based on the received and/or obtained transmission.

### A. General Design of the TCI

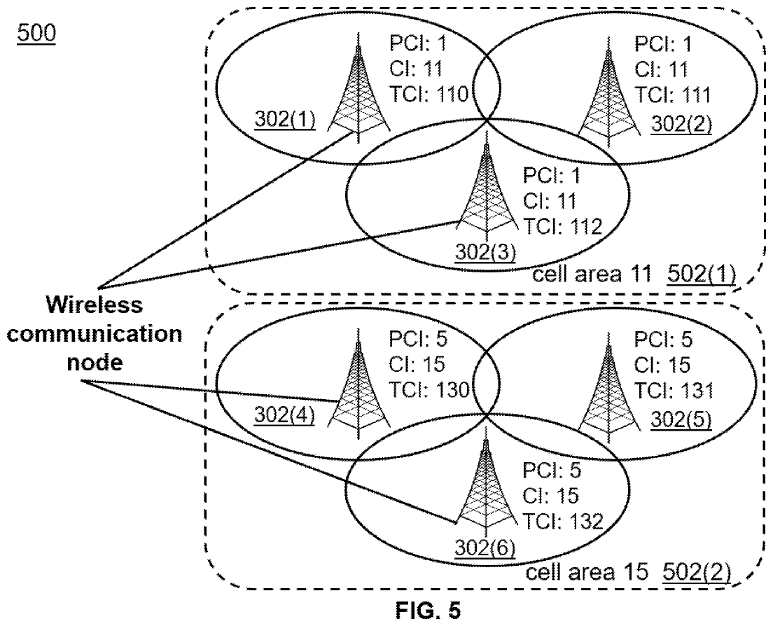

Referring now to FIG. 5, depicted is a block diagram of an example system 500 for identifying radio communication services. A cell area 502 (or domain) may include at least one wireless communication node 302 and be associated with at least one identifier, such as PCI(s), CI(s), TCI(s), and/or other identifiers. The PCI, the Layer-3 (or RRC layer) CI, and/or other identifiers may be utilized as coarse-grained identifiers of the cell area 502. The TCI and/or other identifiers may be defined and/or determined to be utilized as fine-grained identifiers of the cell area 502 (or domain). The wireless communication node(s) 302 may relate and/or associate the TCI and/or other identifiers to one or more antennas (or other transmission or reception device(s)) and/or beams. The wireless communication device(s) may be unaware of the existence and/or presence of said transmission antennas and/or beams. The wireless communication device(s) may relate and/or associate the TCI and/or other identifiers to a transmission control indication state upon receiving at least one transmission. For example, the wireless communication device(s) may relate the TCI to (e.g., use the TCI to describe or include information about) a delay spread upon receiving a SIB and a reference signal. The wireless communication device(s) may receive and/or obtain at least one transmission from the wireless communication node(s) 302, such as a physical channel (e.g., the PBCH and/or other channels) and/or a signal (e.g., a primary synchronization signal (PSS), a secondary synchronization signal (SSS), a CSI-RS, and/or other signals). The wireless communication device(s) may receive and/or obtain the at least one transmission communicated using certain physical resource(s), for example, a synchronization signal/PBCH block (SSB) resource and/or a CSI-RS resource.

The SSB(s) (or other block(s) comprising channels and/or signals) may be related and/or associated to a same identifier(s), such as a same PCI and/or other identifier(s). The SSB(s) with the same identifier(s) (e.g., PCI) may be related and/or mapped to one or more SSB resource(s). Therefore, an identifier that is associated with one or more SSB resources may have at least 30% (e.g., 40, 50 or other percent) higher granularity compared to other identifiers, such as the PCI. A cell may be related to and/or associated with one or more identifier(s), such as the PCI and/or the CI. A cell with a PCI and/or CI may be configured with one or more CSI-RS resources. Therefore, an identifier that is associated with or linked to one or more CSI-RS resources may have at least 30% (e.g., 40, 50 or other percent) higher granularity compared to other identifiers, such as the PCI.

A wireless communication device can determine and/or utilize an identifier (e.g., a transmission control indication state identifier (TCI) and/or other identifiers) to identify a transmission control indication state. A transmission control indication state may comprise various types of information, such as information related to signal reception attributes (e.g., doppler shift, doppler spread, average delay, delay spread, and/or other spatial parameters). The wireless communication device(s) may receive, determine, generate, and/or obtain the TCI from at least one transmission by the wireless communication node(s) 302. For example, the wireless communication device(s) may determine the TCI from multiple transmissions, such as a synchronization signal (e.g., PSS/SSS) and a reference signal (e.g., CSI-RS).

The wireless communication device may determine and/or receive an identity of a domain, such as a cell ID, a service area ID, a PLMN ID, and/or other domain-based identities. The wireless communication device may utilize at least one transmission (e.g., the synchronization signal, the SIB, and/or other transmissions) to determine the identity of the domain. For example, the wireless communication device may utilize the information from a PSS/SSS and/or a SIB1 to determine a cell ID. The wireless communication device may utilize the identity of a domain, and any other information, to determine and/or identify the transmission control indication state(s) within the domain (e.g., a cell, an area, a PLMN, and/or other domains). For example, the wireless communication device may use a PLMN ID together with other information to determine an identifier for the transmission control indication state (e.g., of the PLMN identified by the PLMN ID).

A TCI may be a long bit string (e.g., longer than 16 bits) and/or a large integer. The TCI may be generated, specified, and/or indicated with advertisement information and/or system information (e.g., a SIB1 or other block(s) comprising channels and/or signals). The TCI may be generated, specified, and/or indicated with system information. The system information may be periodically broadcasted and/or provided on-demand, such as requested by the wireless communication device. The TCI(s) may be generated, specified, and/or indicated with a wireless communication device message, such as an RRC configuration message via unicast.

The TCI may be configured to relate to, associate with, and/or link to one or more physical resources. The physical resource(s) may be associated with one or more physical channels and/or signals. The wireless communication device may construct, assemble, form or otherwise determine the TCI upon receiving the physical channel(s) and/or signal(s). The wireless communication device may receive and/or obtain one or more physical resources associated with one or more TCIs. The wireless communication device may be configured to fulfill and/or satisfy a set of rules for TCI selection (e.g., rules for selecting the TCI, rules for unselecting the TCI, rules for reselecting the TCI, and/or other rules or policies). The set of rules for TCI selection may comprise one or more thresholds and/or one or more time intervals. In some embodiments, the wireless communication device(s) may obtain a measurement quantity by measuring, assessing, gathering, and/or comparing information related to the physical resources, the physical channels, and/or the physical signals. The measurement quantity may be compared or assessed accordingly to the set of rules for TCI selection, such as being compared to one or more thresholds. In some embodiments, the wireless communication device(s) may select, deselect, and/or reselect the TCI(s) after at least one time interval of the set of rules for TCI selection.

The TCI(s) can be related, associated, and/or linked to different types of physical resources with different types of physical channel and/or signals. For example, the TCI(s) may be related and/or linked to a SSB resource and a CSI-RS resource. Hence, the TCI(s) may be associated with one or more types of physical resources. In some embodiments, the TCI may comprise one or more fields and/or structures. For example, the most significant bit(s) of the TCI(s) may be the same for one or more physical resources. In this case, the most significant bit(s) of the TCI(s) may be indicated and/or specified once for the one or more physical resources. The most significant bit(s) and the least significant bit(s) of the TCI(s) may be indicated and/or specified separately. For example, the most significant bit(s) of the TCI may be related to a cell identity while the least significant bit(s) of the TCI may be associated with a resource (e.g., a SSB resource, a CSI-RS resource, and/or other resources).

The TCI(s) may be reselected more frequently than other identifiers, such as the CI and/or PCI. The CI, PCI, and/or other identifiers may be reselected based on the selection and/or reselection of the TCI. For example, in response to reselecting the TCI, the CI (or other identifier) may be reselected. The selection, reselection, and/or deselection of the identifiers (e.g., TCI, PCI, CI, and/or other identifiers) may be configured and/or determined by a set of rules, configurations, and/or network parameters. In some embodiments, the wireless communication device(s) may receive and/or obtain one or more configurations regarding the selection, reselection, and/or deselection of the identifiers (e.g., TCI, PCI, CI, and/or other identifiers). In certain embodiments, the wireless communication device(s) may select, reselect, and/or deselect the identifiers using separate configurations. For example, the wireless communication device(s) may select the TCI using a first configuration and may select the CI using a second configuration.

### B. Detailed Design of the TCI

The wireless communication device may determine, generate, and/or establish a TCI using the identity of the domain and/or (information from) at least one transmission from the wireless communication node(s) 302. The identity of the domain may comprise a cell ID, a service area ID, a PLMN ID, and/or other domain identifiers. The identity of the domain may be selected automatically and/or manually specified. The at least one or more transmissions may comprise a SIB, a synchronization signal (e.g., PSS/SSS, or other signals), a PBCH, and/or a RS. For example, the wireless communication device may determine the TCI by using one or more transmissions, (e.g., the SIB and the CSI-RS) and the PLMN ID in the synchronization signal(s) (e.g., the PSS/SSS). In some embodiments, the wireless communication device may determine the identity of the domain by using at least one transmission (e.g., the synchronization signal and/or the SIB). For example, the wireless communication device(s) may determine the cell ID using a SIB1 (e.g., obtain or extract the cell ID from the SIB1). In certain embodiments, the identity of the domain may be determined in conjunction with the determination of the TCI. The identity of the domain may be used (together with a TCI, or as part of the TCI) to identify a transmission control indication state within a domain (e.g., a cell, a service area, a PLMN, and/or other domains).

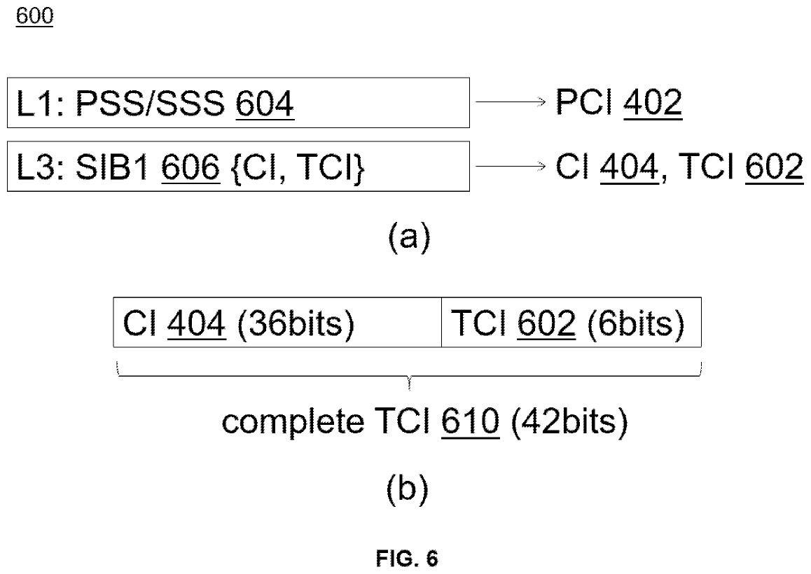

Referring now to FIG. 6, depicted is a representation 600 of an example identifier for identifying radio communication services. The wireless communication device may receive and/or obtain at least one transmission (e.g., the SIB, the PBCH, and/or other transmissions) that indicates and/or provides information (e.g., CI, PCI, SSBI, and/or other information) to determine the TCI. The wireless communication device may determine, create, and/or generate the TCI 610 by using the identity of the domain in the SIB 606 and/or additional information in the SIB 606. For example, the TCI 610 can be generated by using partial information (e.g., a 6-bit partial TCI 602) indicated/provided by the SIB1 and the CI 404 indicated/provided by the SIB1. The synchronization signal(s) (e.g., the PSS/SSS 604) and/or other signals may indicate/provide/include the PCI 402 and/or other identifier(s). The wireless communication device(s) may utilize the PCI 402 and/or other identifiers to determine and/or generate the TCI 610. The synchronization signal(s) may comprise PSS/SSS 604 and/or other signals (or channels) used for radio frame synchronization. The synchronization signal(s) may be carried and/or indicated by the first layer (Layer-1) and/or other layers.

The SIB 606 (and/or other blocks that specify system information) may indicate/provide partial and/or complete information to determine the TCI 610, such as certain identifiers (e.g., the CI 404). For example, the SIB1 606 (and/or other SIBs) may indicate/provide/include a 36-bits (or other bits) CI 404, a 6-bit (or other bits) partial TCI 602, and/or other identifiers or information. The wireless communication device(s) may extract, obtain and/or use the CI 404, the partial TCI 602, and/or identifiers to generate the TCI 610. The CI 404, the partial TCI 602, and/or other identifiers may provide partial and/or complete information to determine the TCI 610. The partial and/or complete information provided by the CI 404, the partial TCI 602, and/or other information may be combined, transformed, and/or used to generate additional information to determine the TCI 610. The block(s) that specify system information (e.g., SIB1, SIB2, SIB3, and/or other blocks) may be carried and/or indicated by the third layer (Layer-3) and/or other layers. The wireless communication device and/or node may utilize other signals, channels, transmissions, and/or information blocks to obtain/extract partial and/or complete information to determine the TCI 610.

The wireless communication device may determine the TCI 610 by utilizing information indicated by the SIB (e.g., the SIB1 606), the synchronization signal(s) (e.g., the PSS/SSS 604), and/or other signals, transmissions, and/or information blocks. For example, a 42-bits (or other bits) TCI 610 may comprise a 36-bits (or other bits) CI 404 and/or a 6-bits (or other bits) partial TCI 610. The CI 404 and/or other identifiers may be indicated by the SIB 606 and/or other blocks, signals, channels, and/or transmissions. The CI 404 may have a length of 36-bits or other lengths. The partial TCI 610 and/or other additional information may be provided/indicated by the SIB 606 and/or other blocks, signals, channels, and/or transmissions. The partial TCI 610 may have a length of 6 bits or other lengths. The TCI 610 may have a length of 42-bits or other lengths. The CI 404, the PCI 402, the partial TCI 602, and/or other types of information may provide, contribute, form, indicate and/or specify the most significant bit(s) of the TCI 610. The CI 404, the PCI 402, the partial TCI 602, and/or other types of information may provide, contribute, form, indicate and/or specify the least significant bit(s) of the TCI 610.

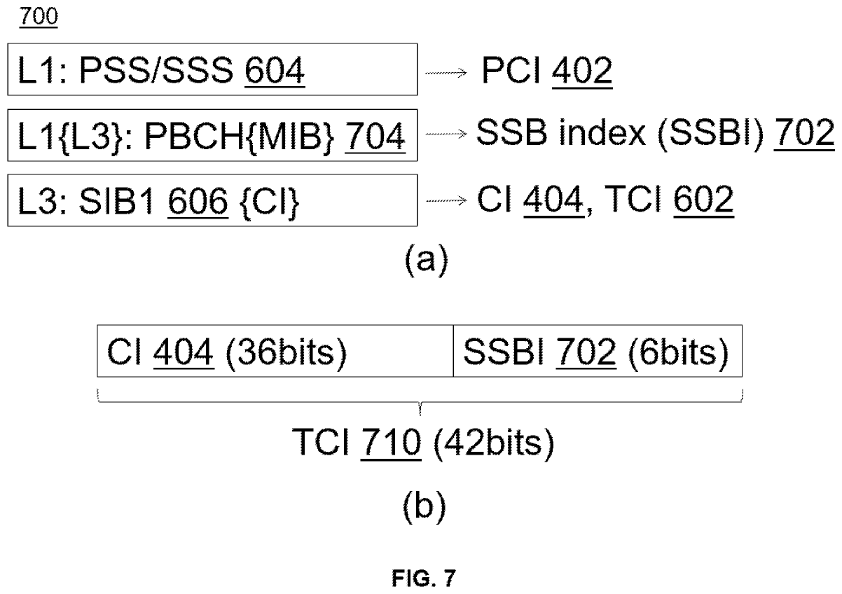

Referring now to FIG. 7, depicted is a representation 700 of an example identifier for identifying radio communication services. The wireless communication device may determine, create, and/or generate the TCI 710 by using the identity of the domain provided in (or obtainable from) the SIB and/or a synchronization signal block index (SSBI) 702 provided in the PBCH. For example, the wireless communication device can generate the TCI 710 by using the CI 404 provided/indicated by the SIB1 and/or the SSBI 702 provided/indicated by the PBCH 704. The synchronization signal(s) (e.g., the PSS/SSS 604), the PCI 402, the SIB 606, the CI 404 and/or the partial TCI 602 may include one or more features already described in connection with FIG. 6, and therefore shall not be described here again.

The PBCH 704 and/or other channels may provide/indicate partial and/or complete information to determine/form the TCI 710, such as the master information block (MIB) and/or the SSBI 702. The SSBI 702 may be used to assign and/or indicate a system synchronization block (SSB). In some embodiments, the PBCH 704 (and/or other channels) may be used to obtain/indicate/provide a 6-bits (or other bits) SSBI 702 and/or other identifier, index, or information. The SSBI 702 may have a length of 6-bits or other lengths. The wireless communication device may utilize the SSBI 702, the MIB, and/or other information to generate the TCI 710. The SSBI 702, the MIB, the PCI 402, the CI 404, the partial TCI 602 and/or other information may provide partial and/or complete information to determine the TCI 710. The partial and/or complete information provided by the SSBI 702, the MIB, the PCI 402, the CI 404, the partial TCI 602 and/or other information may be combined, appended, processed, transformed, and/or used to generate additional information to determine the TCI 710. The channel(s) that provide/specify information of the TCI 710 (e.g., the PBCH) may be carried, indicated, and/or transmitted via the first layer (Layer-1) and/or other layers.

The wireless communication device may determine the TCI 710 by utilizing information indicated/provided by the SIB 606, the PBCH 704, and/or other signals, transmissions, and/or information blocks. For example, a 42-bits (or other bits) TCI 710 may comprise a 36-bits (or other bits) CI 404 and/or a 6-bits (or other bits) SSBI 702. The CI 404, the SSBI 702, and/or other types of information may form, contribute, provide, indicate and/or specify the most significant bit(s) of the TCI 710, for example. The CI 404, the SSBI 702, and/or other types of information may form, contribute, provide, indicate and/or specify the least significant bit(s) of the TCI 710. This and other examples are provided only by way of illustration, as the components forming the TCI can be arranged in any other order.

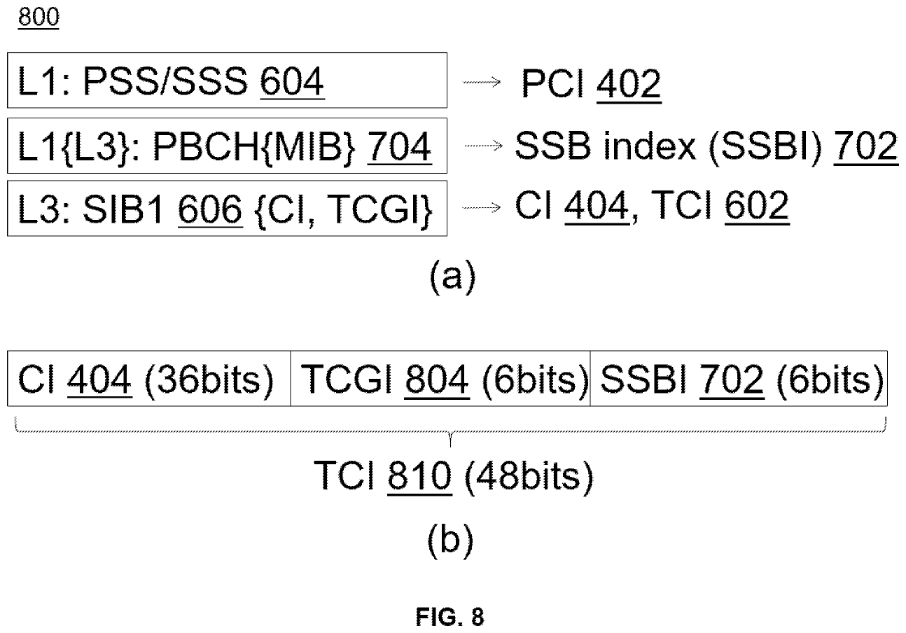

Referring now to FIG. 8, depicted is a representation 800 of an example identifier for identifying radio communication services. The wireless communication device may determine, create, and/or generate the TCI 810 by using the identity of the domain provided in (or obtainable/extracted from) the SIB, a transmission control indication state group identity (TCGI) 804 in the SIB 606, and/or a SSBI 702 in the PBCH 704. For example, the wireless communication device can generate the TCI 810 by using the CI 404 provided/indicated by the SIB1 606, the TCGI 804 provided/indicated by the SIB1 606, and/or the SSBI 702 provided/indicated by the PBCH 704. The synchronization signal(s) (e.g., the PSS/SSS 604), the PCI 402, the SIB 606, the CI 404 and/or the partial TCI 602 may each include one or more features described in connection with FIGS. 6-7. The PBCH 704, the MIB, and/or the SSBI 702 may each include one or more features described in connection with FIG. 7.

The SIB 606 (and/or other blocks that specify system information) may provide/indicate partial and/or complete information to determine the TCI 810, such as the CI 404, the TCGI 804, and/or other information. For example, the SIB1 606 (and/or other SIB s) may provide/indicate/include a 36-bits (or other bits) CI 404, a 6-bit (or other bits) TCGI 804, and/or other information. The wireless communication device(s) may use the CI 404, the TCGI 804, and/or other information to generate the TCI 810. The TCGI 804 and/or other identifiers may provide partial and/or complete information to determine the TCI 810. The partial and/or complete information provided by the TCGI 804 may be combined, transformed, processed and/or otherwise used to generate additional information to determine/form the TCI 810.

The wireless communication device may determine the TCI 810 by utilizing information provided/indicated by the SIB 606, the PBCH 704, and/or other signals, transmissions, and/or information blocks. For example, a 48-bits (or other bits) TCI 810 may comprise a 36-bits (or other bits) CI 404, a 6-bits (or other bits) SSBI 702, and/or a 6-bits (or other bits) TCGI 804. The TCGI 804 can comprise a transmission control indication state region ID and/or a transmission control indication state set ID. The TCGI 804 may be provided/indicated by the SIB 606 (e.g., SIB1) and/or other signal, transmissions, and/or information blocks. The TCGI 804 may have a length of 6-bits or other lengths. The TCGI 804, the CI 404, the partial TCI 602, the PCI 402, the SSBI 702 and/or other identifiers may be conveyed/provided/indicated using one or more separate transmissions.

The CI 404, the SSBI 702, the TCGI 804, and/or other types of information may form, contribute, indicate and/or specify the most significant bit(s) of the TCI 810. The CI 404, the SSBI 702, the TCGI 804, and/or other types of information may form, contribute, indicate and/or specify the least significant bit(s) of the TCI 810. The CI 404, the SSBI 702, and/or the TCGI 804 may be arranged, placed and/or combined in any order to generate/form the TCI 810. For example, the wireless communication device(s) may generate the TCI 810 by placing the SSBI 702 in the leftmost position, the TCGI 804 in the rightmost position, and the CI 404 in the middle position.

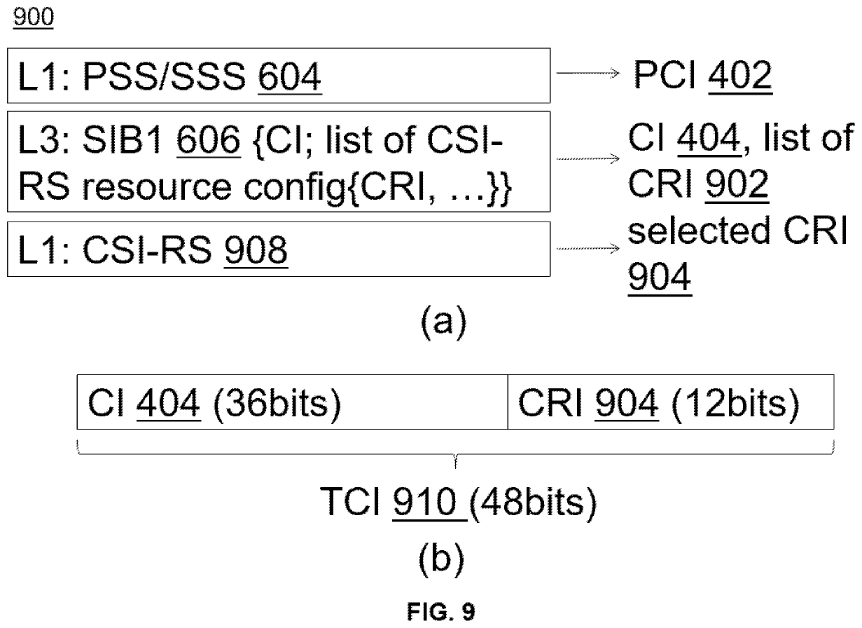

Referring now to FIG. 9, depicted is a representation 900 of an example identifier for identifying radio communication services. The wireless communication device may determine, create, form, assemble and/or generate the TCI 910 by using the identity of the domain and/or a CSI-RS resource index (CRI) in the SIB, a CRI selected (from a plurality/list of CRIs included/specified in the SIB) according to (information in) the CSI-RS. For example, the wireless communication device can generate the TCI 910 by using the CI 404 provided/indicated by the SIB1 906 and/or the selected CRI 904. The synchronization signal(s) (e.g., the PSS/SSS 604), the PCI 402, the SIB 606, and/or the CI 404 may each include one or more features described in connection with FIGS. 6-8.

The SIB 606 (and/or other blocks that specify system information) may provide/indicate partial and/or complete information to form/determine the TCI 910, such as the CI 404, the CRI 904, the TCGI 804, a list of CRIs 902, a list of TCI information 1002, and/or other information. For example, the SIB1 (and/or other SIB s 606) may provide/indicate a 36-bits (or other bits) CI 404, a 12-bit (or other bits) CRI 904, a 6-bits (or other bits) TCGI, a 12-bits (or other bits) TCI, a list of CRIs 902, a list of TCI information 1002, and/or other information. The SIB 606 (and/or other blocks that specify system information) may include/provide/indicate a list of CRIs 902, a list of TCI information 1002, and/or a list of other information. The list of CRIs 902 may comprise one or more CRI 904. The list of TCI information 1002 may comprise one or more TCI information 1004. For example, the SIB1 606 may indicate a list of CRIs 902 comprising one or more CRIs 904. The wireless communication device and/or node can utilize other signals, blocks, messages, and/or channels to provide the list of CRI 902, the list of TCI information 1002, and/or other lists of information.

The wireless communication device may receive and/or obtain the CSI-RS 908 and/or other reference signals. The wireless communication device may utilize information provided by the CSI-RS 908 and/or other reference signals to select a CRI 904 from the list of CRIs 902. The wireless communication device may utilize information provided by the CSI-RS 908 and/or other reference signals to select the TCI information 1004 from the list of TCI information 1002. The information provided by the CSI-RS 908 may comprise channel state information, channel quality information, and/or other types of information. The list of CSI-RS resource configuration in the SIB 606 may indicate a relationship and/or association between the TCI information 1004 and/or the CRI 904 and a CSI-RS resource. The wireless communication device(s) may use other reference signals (e.g., demodulation reference signal, sounding reference signals, and/or other signals) to select the CRI 904 and/or TCI information 1004 from the list of CRI 902 and/or the list of TCI information 1002.

The wireless communication device(s) may use the CI(s) 404, the CRI(s) 904, the list(s) of CRIs 902, the CSI-RS 908, and/or other information to generate/form/assemble the TCI 910. The CRI 904, the list of CRIs 902, the CSI-RS 908, and/or other types of information may provide partial and/or complete information to determine/form the TCI 910. The partial and/or complete information provided by the CRI 904, the list of CRIs 902, the CSI-RS 908, and/or other information may be combined, transformed, and/or used to generate additional information to determine the TCI 910.

The wireless communication device(s) may determine the TCI 910 by utilizing information provided/indicated by the SIB 606, the CSI-RS 908, and/or other signals, transmissions, and/or information blocks. For example, a 48-bits (or other bits) TCI 910 may comprise a 36-bits (or other bits) CI 404, and/or a 12-bits (or other bits) CRI 904. The CRI 904 may be provided/indicated by the SIB 606 (e.g., SIB1) and/or other signal, transmissions, and/or information blocks. The CRI 904 may have a length of 12-bits or other lengths. The CRI 904, the TCI information 1004, the list of CRI 902, the list of TCI information 1002, and/or other information may be provided/indicated using/via one or more separate transmissions.

The CI 404, the CRI 904, and/or other types of information may provide, form, contribute, indicate and/or specify the most significant bit(s) of the TCI 910. The CI 404, the CRI 904, and/or other types of information may provide, form, contribute, indicate and/or specify the least significant bit(s) of the TCI 910. Other arrangements, orders and/or combinations are possible and are contemplated.

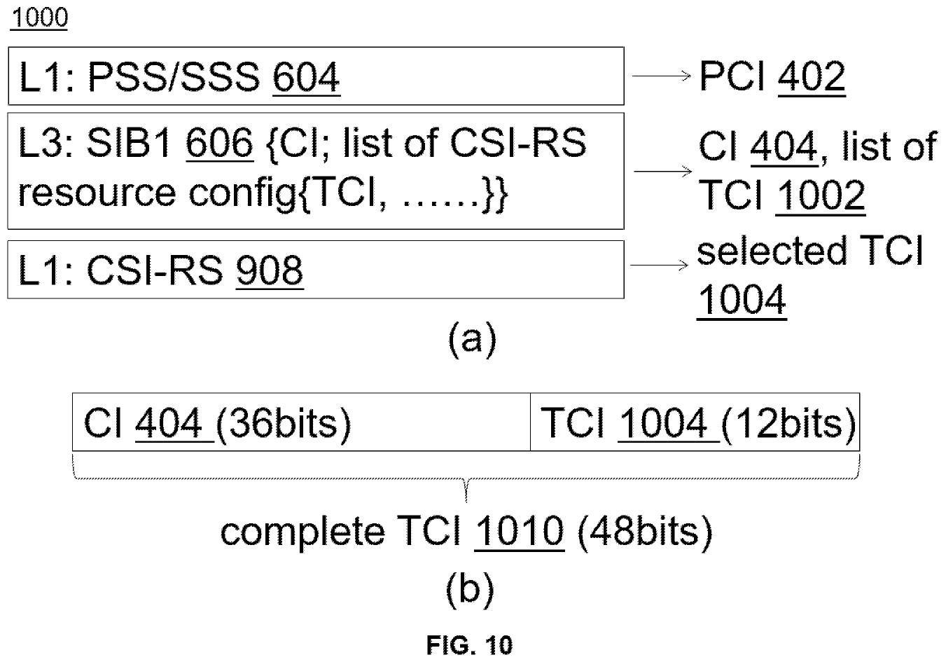

Referring now to FIG. 10, depicted is a representation 1000 of an example identifier for identifying radio communication services. The wireless communication device may determine, create, and/or generate the TCI 1010 by using the identity of the domain and/or TCI information provided in (or obtainable/extracted from) the SIB, the TCI information selected (from a list of TCI information) according to the CSI-RS. For example, the wireless communication device can generate the TCI 1010 by using the CI 404 indicated by the SIB1 606 and/or the selected TCI information 1004. The synchronization signal(s) (e.g., the PSS/SSS 604), the PCI 402, the SIB 606, the CI 404, the list of TCI information 1002, the CSI-RS 908, and/or the TCI information 1004 may each include one or more features described in connection with FIGS. 6-9.

The wireless communication device(s) may determine the TCI 1010 by utilizing information provided/indicated by the SIB (e.g., the SIB1 606), the synchronization signal(s) (e.g., the PSS/SSS 604), the reference signal(s) (e.g., the CSI-RS 908) and/or other signals, transmissions, and/or information blocks. For example, a 48-bits (or other bits) TCI 1010 may comprise a 36-bits (or other bits) CI 404, and/or a 12-bits (or other bits) TCI information 1004. The SIB 606 (and/or other blocks that specify system information) may provide/indicate partial and/or complete information to determine the TCI 1010, such as the CI 404, the TCI information 1004, the list of TCI information 1002, and/or other information.

The TCI information 1004 may be provided/indicated by the SIB (e.g., SIB1 606) and/or other signal, transmissions, and/or information blocks. The TCI information 1004 may have a length of 12-bits or other lengths. The TCI information 1004 may be selected and/or identified by utilizing information provided by reference signal(s) (e.g., the CSI-RS 908) and/or other signals or information. The TCI information 1004 may be selected and/or identified from the list of TCI information 1002. The TCI information 1004 and/or other types of information may provide partial and/or complete information to determine/form the TCI 1010. The partial and/or complete information provided by the TCI information 1004 may be combined, arranged, processed, transformed, and/or used to generate additional information to determine the TCI 1010.

The CI 404, the TCI information 1004, and/or other types of information may form, contribute, indicate and/or specify the most significant bit(s) of the TCI 1010. The CI 404, the TCI information 1004, and/or other types of information may form, contribute, indicate and/or specify the least significant bit(s) of the TCI 1010. Other arrangements, orders and/or combinations are possible and are contemplated.

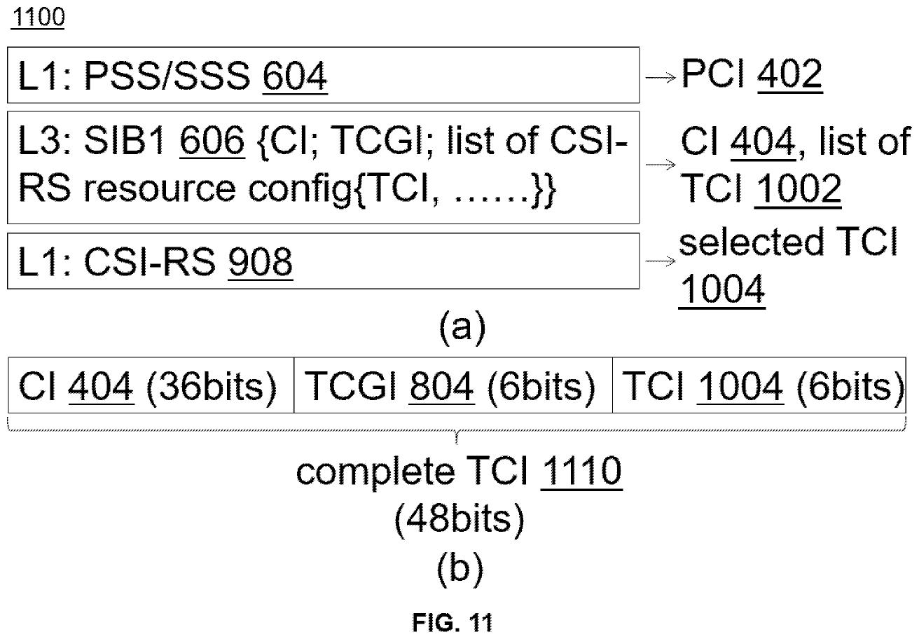

Referring now to FIG. 11, depicted is a representation 1100 of an example identifier for identifying radio communication services. The wireless communication device may determine, create, and/or generate the TCI 1110 by using the identity of the domain, the TCGI and/or TCI information provided in (or obtained/extracted from) the SIB, the TCI information selected (from a list/collection of TCI information) according to the CSI-RS. For example, the wireless communication device can generate the TCI 1110 by using the CI 404 provided/indicated by the SIB1 606, the TCGI 804 provided/indicated by the SIB1 606, and/or the TCI information 1004 selected from the list of TCI information 1002. The synchronization signal(s) (e.g., the PSSS/SSS 604), the PCI 402, the SIB 606, the CI 404, the list of TCI information 1002, the TCGI 804, the CSI-RS 908, and/or the TCI information 1004 may each include one or more features described in connection with FIGS. 6-10.

A 48-bits (or other bits) TCI 1110 may comprise a 36-bits (or other bits) CI 404, a 6-bits (or other bits) TCGI 804, and/or a 12-bits (or other bits) TCI information 1004. The CI 404, the TCGI 804, the TCI information 1004, and/or other types of information may form, contribute, indicate and/or specify the most significant bit(s) of the TCI 1110. The CI 404, the TCGI 804, the TCI information 1004, and/or other types of information may form, contribute, indicate and/or specify the least significant bit(s) of the TCI 1110. The CI 404, the TCI information 1004, and/or the TCGI 804 may be placed and/or combined in any order to generate the TCI 1110. For example, the TCI 1110 may be generated by placing the TCI information 602 in the leftmost position, the TCGI 804 in the rightmost position, and the CI 404 in the middle position.

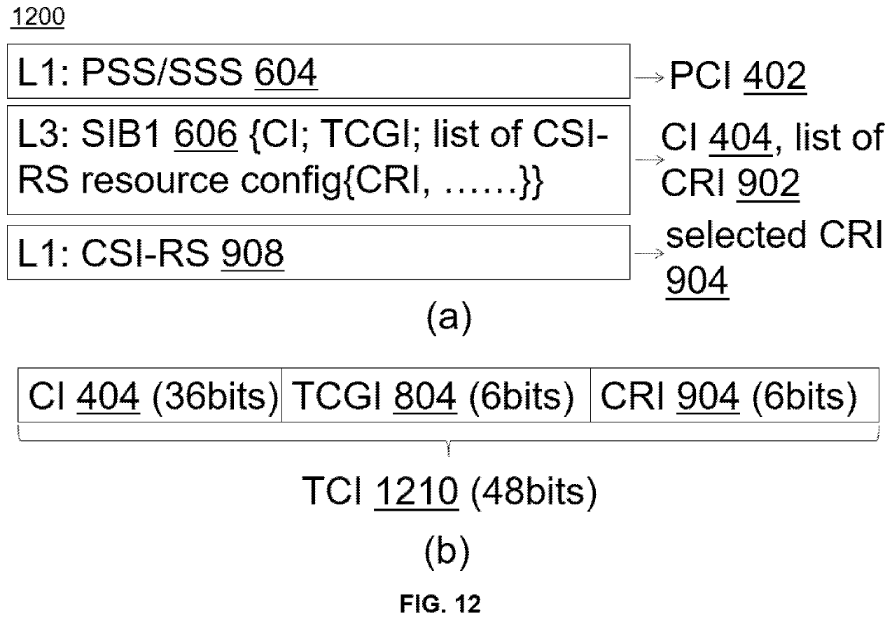

Referring now to FIG. 12, depicted is a representation 1200 of an example identifier for identifying radio communication services. The wireless communication device may determine, create, assemble and/or generate the TCI 1210 by using the identity of the domain, the TCGI and/or the CRI in the SIB, the CRI selected according to the CSI-RS. For example, the wireless communication device can generate the TCI 1210 by using the CI 404 indicated by the SIB1 606, the TCGI 804 provided/indicated by the SIB1 606, and/or the CRI 904 selected from the list of CRI 902. The synchronization signal(s) (e.g., the PSS/SSS 604), the PCI 402, the SIB 606, the CI 404, the list of CRI 902, the TCGI 804, the CSI-RS 908, and/or the CRI 904 may each include one or more features described in connection with FIGS. 6-10.

A 48-bits (or other bits) TCI 1210 may comprise a 36-bits (or other bits) CI 404, a 6-bits (or other bits) TCGI 804, and/or a 6-bits (or other bits) CRI 904. The SIB 606 (and/or other blocks that specify system information) may provide/indicate partial and/or complete information to determine the TCI 1210, such as the CI 404, the TCGI 804, the CRI 904, the list of CRI 902, and/or other information. The CI 404, the TCGI 804, the CRI 904, and/or other types of information may contribute, form, indicate and/or specify the most significant bit(s) of the TCI 1210. The CI 404, the TCGI 804, the CRI 904, and/or other types of information may contribute, form, indicate and/or specify the least significant bit(s) of the TCI 1210. The wireless communication device(s) may place and/or combine the CI 404, the CRI 904, and/or the TCGI 804 in any order to generate the TCI 1210. For example, the wireless communication device(s) may generate the TCI 1210 by placing the CRI 904 in the leftmost position, the TCGI 804 in the rightmost position, and the CI 404 in the middle position.

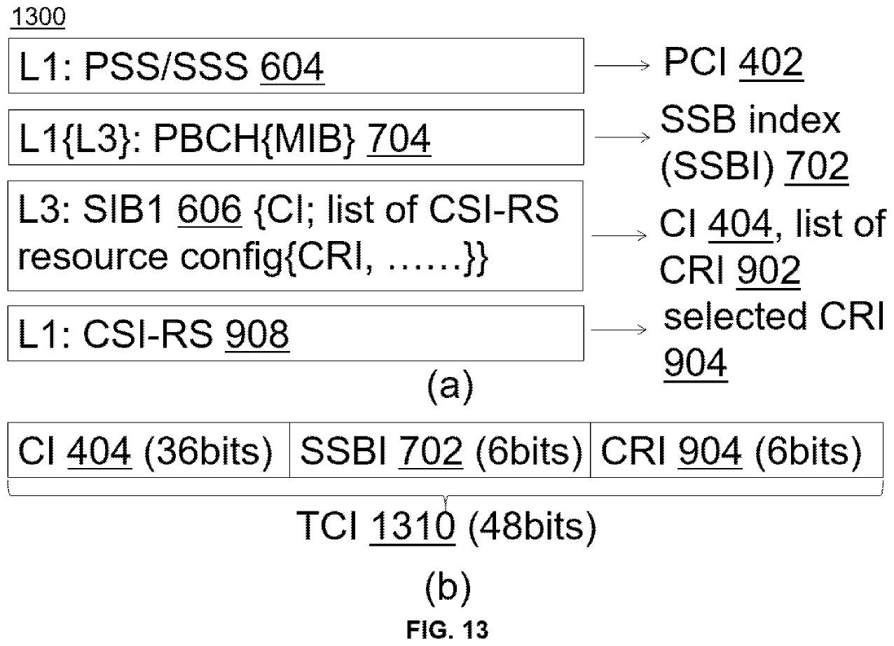

Referring now to FIG. 13, depicted is a representation 1300 of an example identifier for identifying radio communication services. The wireless communication device may determine, form, assemble, create, and/or generate the TCI 1310 by using the identity of the domain and the CRI in the SIB, and/or a SSBI in the PBCH, the CRI selected (from a list/plurality of CRIs) according to the CSI-RS. For example, the wireless communication device can generate the TCI 1310 by using the CI 404 provided/indicated by the SIB1 606, the SSBI 702 provided/indicated by the PBCH 704, and/or the CRI 904 selected from the list of CRI 902. The synchronization signal(s) (e.g., the PSS/SSS 604), the PCI 402, the PBCH 704, the MIB, the SSBI 702, the SIB 606, the CI 404, the list of CRI 902, the CSI-RS 908, and/or the CRI 904 may each include one or more features described in connection with FIGS. 6-10.

The list of CSI-RS 908 resource configuration may provide, indicate and/or specify the SSBI 702. The SSBI 702 specified in the list may indicate the quasi-co-location (QCL) relationship between the CSI-RS 908 resource and the SSB. In some embodiments, the SSBI 702 and the CRI 904 may have a QCL relationship with the SSBI 702 and the CSI-RS 908 respectively.

A 48-bits (or other bits) TCI 1310 may comprise a 36-bits (or other bits) CI 404, a 6-bits (or other bits) SSBI 702, and/or a 6-bits (or other bits) CRI 904. The PBCH 704 (and/or other channels) may provide partial and/or complete information to determine the TCI 1310, such as the SSBI 702 and/or other information. The CI 404, the SSBI 702, the CRI 904, and/or other types of information may form, contribute, indicate and/or specify the most significant bit(s) of the TCI 1310. The CI 404, the SSBI 702, the CRI 904, and/or other types of information may form, contribute, indicate and/or specify the least significant bit(s) of the TCI 1310. The wireless communication device(s) may arrange, place and/or combine the CI 404, the CRI 904, and/or the SSBI 702 in any order to generate the TCI 1310. For example, the wireless communication device(s) may generate the TCI 1310 by placing the CRI 904 in the leftmost position, the SSBI 702 in the rightmost position, and the CI 404 in the middle position.

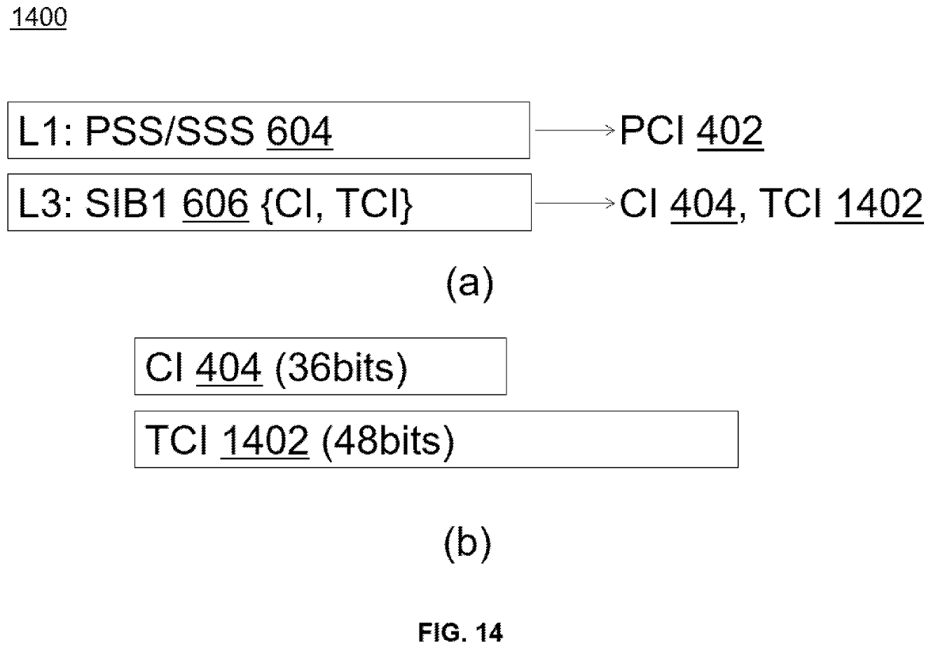

Referring now to FIG. 14, depicted is a representation 1400 of an example identifier for identifying radio communication services. The wireless communication device may determine, create, and/or generate the TCI 1402 by using information provided in (or obtainable/extracted from) the SIB 606. The determined TCI 1402 may be independent of the information provided by the CI 404. The synchronization signal(s) (e.g., the PSS/SSS 604), the PCI 402, the SIB 606, and/or the CI 404 may each include one or more features described in connection with FIGS. 6-10.

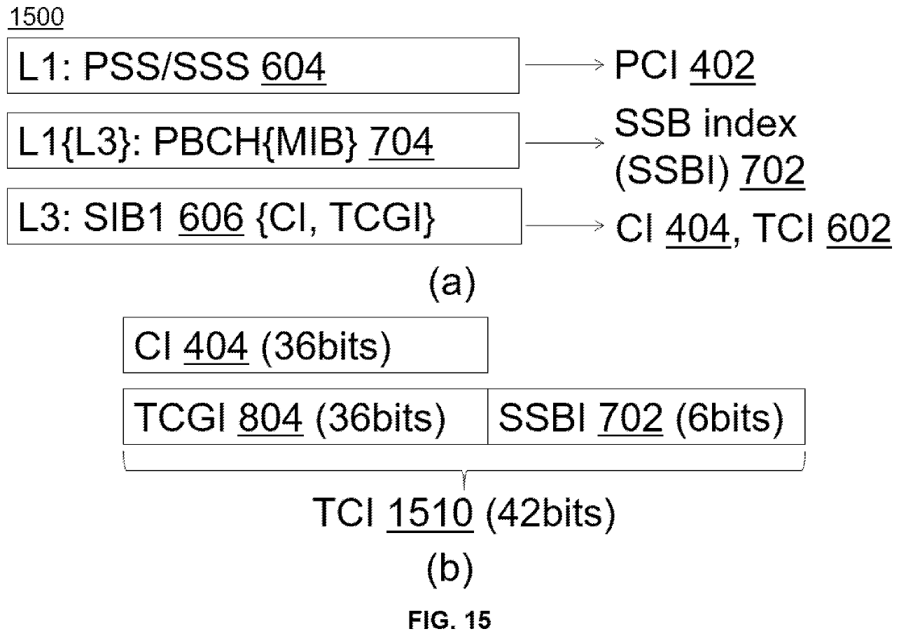

Referring now to FIG. 15, depicted is a representation 1500 of an example identifier for identifying radio communication services. The wireless communication device may determine, create, and/or generate the TCI 1510 by using the TCGI 804 include in (or obtainable/extracted from) the SIB, and/or a SSBI 702 in the PBCH. The determined TCI 1510 may be independent of the information provided by the CI 404. The synchronization signal(s) (e.g., the PSS/SSS 604), the PCI 402, the PBCH 704, the MIB, the SSBI 702, the SIB 606, the CI 404, and/or the TCGI 804 may each include one or more features described in connection with FIGS. 6-10.

The wireless communication device may determine the TCI 1510 by utilizing information provided/indicated by the SIB (e.g., the SIB1 606), the synchronization signal(s) (e.g., the PSS/SSS 604), the PBCH 704, and/or other signals, transmissions, channels, and/or information blocks. The TCGI 804, the SSBI 702, and/or other types of information may form, contribute, indicate and/or specify the most significant bit(s) of the TCI 1510. The TCGI 804, the SSBI 702, and/or other types of information may form, contribute, indicate and/or specify the least significant bit(s) of the TCI 1510.

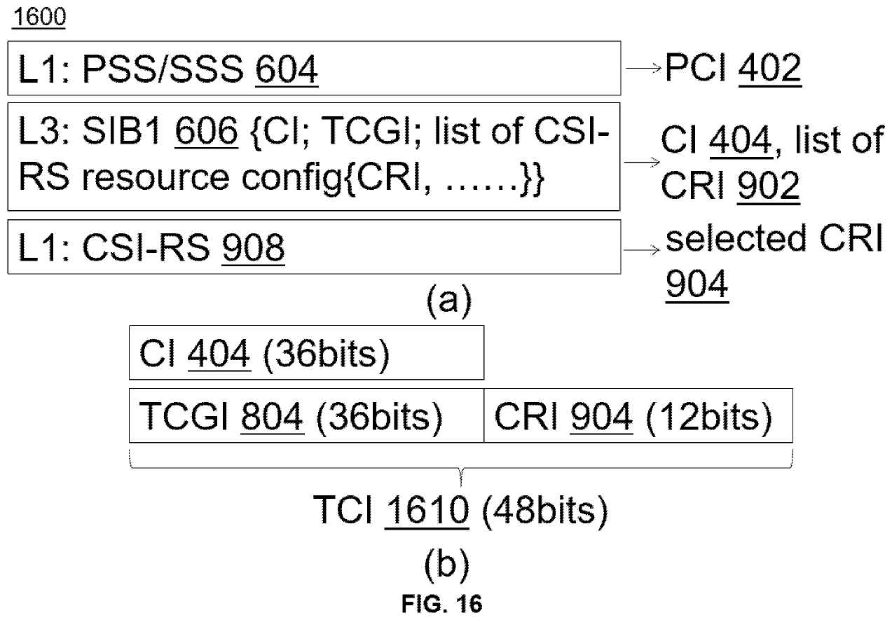

Referring now to FIG. 16, depicted is a representation 1600 of an example identifier for identifying radio communication services. The wireless communication device may determine, create, and/or generate the TCI 1610 by using the TCGI and/or the CRI in the SIB, the CRI selected according to the CSI-RS. The determined TCI 1610 may be independent of the information provided by the CI 404. For example, the wireless communication device can assemble, form or generate the TCI 1610 by using the TCGI 804 indicated by the SIB1 606, and/or the CRI 904 selected from the list of CRIs 902. The synchronization signal(s) (e.g., the PSS/SSS 604), the PCI 402, the SIB 606, the CI 404, the list of CRIs 902, the TCGI 804, the CSI-RS 908, and/or the CRI 904 may each include one or more features described in connection with FIGS. 6-10.

A 48-bits (or other bits) TCI 1610 may comprise a 36-bits (or other bits) TCGI 804, and/or a 12-bits (or other bits) CRI 904. The TCGI 804, the CRI 904, and/or other types of information may form, contribute, indicate and/or specify the most significant bit(s) of the TCI 1610. The TCGI 804, the CRI 904, and/or other types of information may form, contribute, indicate and/or specify the least significant bit(s) of the TCI 1610.

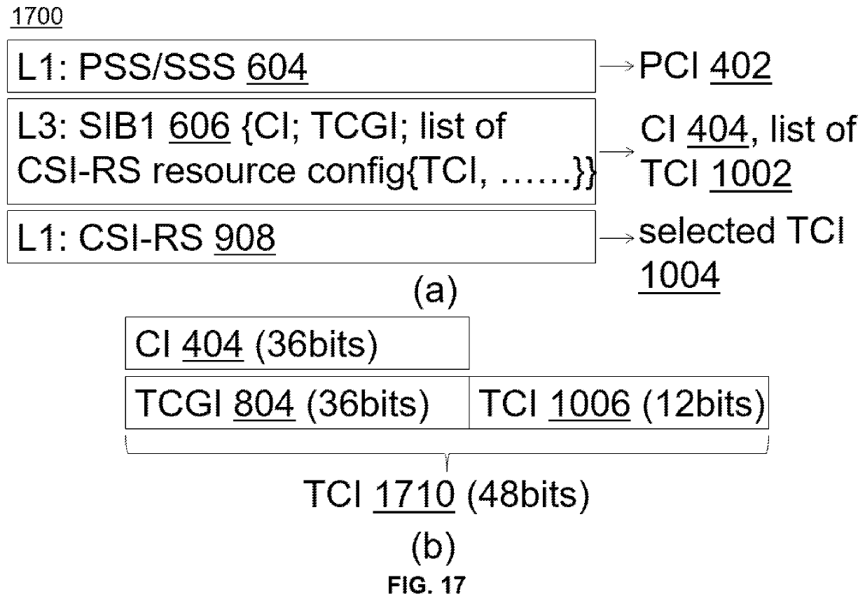

Referring now to FIG. 17, depicted is a representation 1700 of an example identifier for identifying radio communication services. The wireless communication device may determine, create, and/or generate the TCI 1710 by using the TCGI and/or the TCI information included in (or obtainable/derived from) the SIB, the TCI information selected (from a list/collection of TCI information) according to the CSI-RS. The determined TCI 1710 may be independent of the information provided by the CI 404. For example, the wireless communication device can generate the TCI 1710 by using the TCGI 804 provided/indicated by the SIB1 606, and/or the TCI information 1004 selected from the list of TCI information 1002. The synchronization signal(s) (e.g., the PSS/SSS 604), the PCI 402, the SIB 606, the CI 404, the list of TCI information 1002, the TCGI 804, the CSI-RS 908, and/or the TCI information 1004 may include one or more features described in connection with FIGS. 6-10.

The 48-bits (or other bits) TCI 1710 may comprise a 36-bits (or other bits) TCGI 804, and/or a 12-bits (or other bits) TCI information 1004. The TCGI 804, the TCI information 904, and/or other types of information may form, contribute, indicate and/or specify the most significant bit(s) of the TCI 1710. The TCGI 804, the TCI information 904, and/or other types of information may form, contribute, indicate and/or specify the least significant bit(s) of the TCI 1710. Other combinations, arrangements and orders are possible and contemplated.

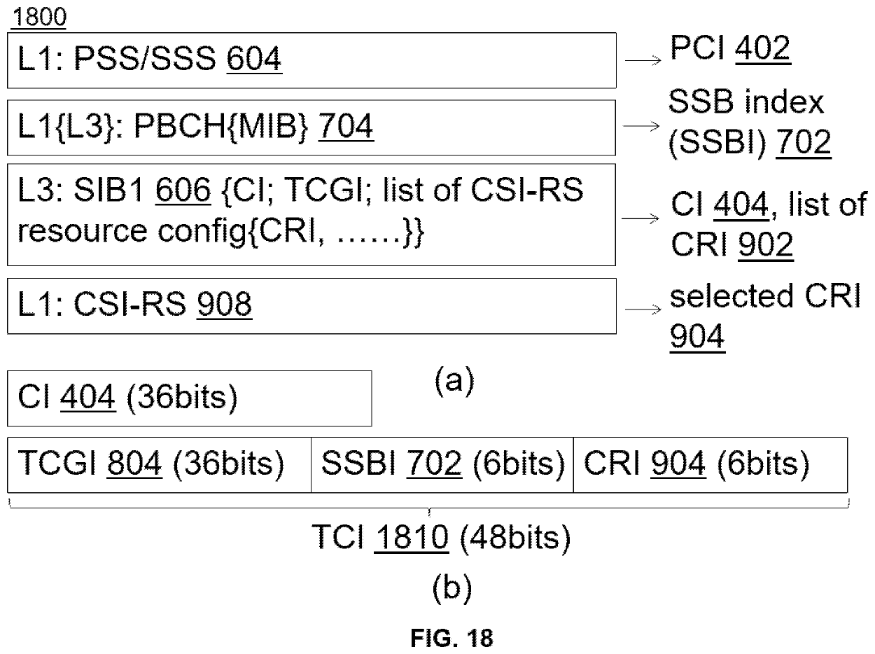

Referring now to FIG. 18, depicted is a representation 1800 of an example identifier for identifying radio communication services. The wireless communication device may form, determine, create, and/or generate the TCI 1810 by using the TCGI and the CRI in (or derivable/extracted from) the SIB, and/or the SSBI in the PBCH, the CRI selected (from a list of CRIs) according to the CSI-RS. The determined TCI 1810 may be independent of the information provided by the CI 404. For example, the wireless communication device can generate the TCI 1810 by using the TCGI 804 indicated by the SIB1 606, the SSBI 702 indicated by the PBCH 704, and/or the CRI 904 selected from the list of CRI 902. The synchronization signal(s) (e.g., the PSS/SSS 604), the PCI 402, the PBCH 704, the SSBI 702, the SIB 606, the CI 404, the CRI 902, the TCGI 804, the CSI-RS 908, and/or the list of CRIs 904 may each include one or more features described in connection with FIGS. 6-10.

A 48-bits (or other bits) TCI 1810 may comprise a 36-bits (or other bits) TCGI 804, a 6-bits (or other bits) SSBI 702, and/or a 6-bits (or other bits) CRI 904. The TCGI 804, the SSBI 702, the CRI 904, and/or other types of information may form, contribute, indicate and/or specify the most significant bit(s) of the TCI 1810. The TCGI 804, the SSBI 702, the CRI 904, and/or other types of information may form, contribute, indicate and/or specify the least significant bit(s) of the TCI 1810. The wireless communication device(s) may place and/or combine the TCGI 804, the CRI 904, and/or the SSBI 702 in any order to generate the TCI 1810. For example, the wireless communication device(s) may generate the TCI 1810 by placing the CRI 904 in the leftmost position, the SSBI 702 in the rightmost position, and the TCGI 804 in the middle position.

In some embodiments, other types of service function identifiers and/or service area identifiers may be used to replace the cell identity. For example, other types of service function identifiers and/or service area identifiers may be utilized in cell-free and/or cell-less wireless communication systems. In such embodiments, the TCI may be used and/or determined as an at least 30% (or other percent) finer-grained unambiguous identifier.

### C. Further Uses for the TCI

In some embodiments, the wireless communication device(s) may identify a location by using and/or analyzing the information of the TCI(s). The TCI(s) may be related and/or associated with one or more transmission antennas and/or beams. Therefore, the TCI(s) may be related to and/or associated with one or more locations of the wireless communication device. The wireless communication device(s) can utilize the TCI(s) as location identifier(s) with at least 30% (or other percent) higher granularity than the PCI(s) and/or the CI(s).

The wireless communication device(s) may report, transmit, and/or send the TCI(s) to the wireless communication node(s) and/or a third party to identify and/or determine the location(s) of the wireless communication device(s) and/or for other purposes. The wireless communication device(s) can report, transmit, and/or send the TCI(s) with a measurement, a radio link failure, a beam failure, a minimization of drive test (MDT), and/or other measurements, messages, transmissions, and/or reports. For example, the TCI(s) may be reported (e.g., with the measurement(s), the beam failure(s), and/or the radio link failure(s)) for network optimization or test purposes (e.g., self-optimization network (SON), MDT, and/or other purposes). The TCI(s) may be reported for data collection and/or analysis purposes.

The wireless communication device(s) may select, reselect, and/or deselect the TCI(s) a number of times. The wireless communication device(s) and/or the wireless communication node(s) may use the number of TCI selections, reselections, and/or deselections to determine one or more mobility states of the wireless communication device(s). For example, the number of TCI reselections during a time period may be compared to a configured number of TCI reselections (or a configured set comprising one or more numbers of TCI reselections) to determine the mobility state(s) of the wireless communication device(s). The time period(s) or interval(s), the number of TCI reselections, the set(s) comprising one or more numbers of TCI reselections, and/or other relevant parameters may be configured by the wireless communication device(s), the wireless communication node(s), the wireless communication network, and/or other components of the wireless communication system.

### D. Methods of Identifying Radio Communication Services

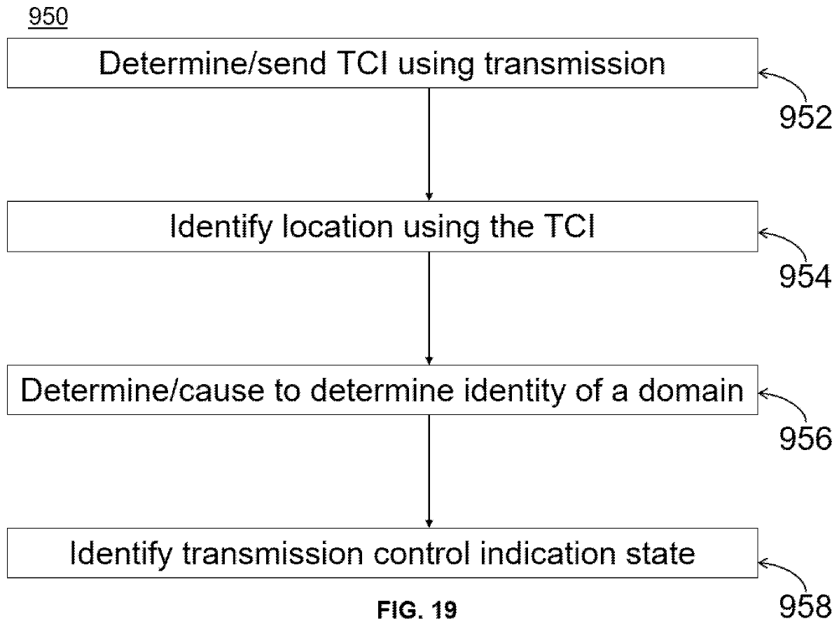

FIG. 19 illustrates a flow diagram of a method 950 of identifying radio communication services. The method 950 may be implemented using any of the components and devices detailed herein in conjunction with FIGS. 1-18. In overview, the method 950 may include determining and/or sending a TCI using a transmission (952). The method 950 may include identifying the location using the TCI (954). The method 950 may include determining and/or causing to determine an identity of a domain (956). The method 950 may include identifying a transmission control indication state (958).

Referring now to operation (952), and in some embodiments, the wireless communication device may determine, generate, and/or establish a transmission control indication state identifier (TCI) according to at least one transmission from a wireless communication node. The wireless communication node(s) may send at least one transmission to the wireless communication device(s) to determine the TCI. The at least one transmission may comprise at least one of a system information block (SIB) (e.g., SIB1, SIB2, and/or other SIB s), a synchronization signal (e.g., PSS/SSS, and/or other signals), a physical broadcast channel (PBCH), and/or a reference signal (RS) (e.g., CSI-RS and/or other signals). The wireless communication device(s) and/or node(s) may utilize other signals, messages, channels, and/or transmissions to provide and/or communicate information to determine/form the TCI. For example, the wireless communication node(s) may send and/or transmit the SIB1 and the PSS/SSS to the wireless communication device(s). The wireless communication device(s) may determine, generate, and/or create the TCI(s) according to the information indicated and/or provided by the SIB1 and/or the PSS/SSS. The wireless communication device(s) may utilize complete and/or partial information from the transmission(s) to determine and/or generate the TCI(s). The wireless communication device(s) may generate other information to determine the TCI(s) by combining, transforming, analyzing, and/or using the information from the transmission(s). The wireless communication device(s) may determine the TCI(s) by utilizing and/or combining the information provided by prior transmissions.

Responsive to determining the TCI(s), the wireless communication device(s) can identify or be caused to identify a transmission control indication state and/or a location. The wireless communication device(s) may report or be caused to report the TCI to other wireless communication device(s), the wireless communication node(s), and/or other components of a wireless communication system.

Referring now to operation (954), and in some embodiments, the wireless communication device(s) may identify or be caused to identify a location using the TCI. Responsive to determining and/or generating the TCI(s), the wireless communication device(s) may identify or be caused to identify one or more locations using the TCI(s). The wireless communication device(s) may be caused to identify the location(s) by the wireless communication device(s), the wireless communication node(s), and/or other entities. The wireless communication device(s) may be caused to identify the location(s) upon receiving at least one transmission from the wireless communication node(s). For example, the wireless communication device(s) may be caused to identify the location(s) upon receiving information from the PBCH (or other channels) and/or the synchronization signal(s) (e.g., the PSS/SSS). The location(s) can comprise a service area, a set of coordinates, a distance from the wireless communication node(s), and/or other locations. The location(s) can comprise the location(s) of the wireless communication device(s), the location(s) of other wireless communication device(s), and/or the location(s) of other entities of the wireless communication system.

The wireless communication device(s) may use complete and/or partial information provided by the TCI(s) to identify the location. The wireless communication device(s) may combine the information provided by the TCI(s) with other sources of information (e.g., the PSS/SSS, the SIB, and/or other transmissions) to identify the location. The wireless communication device(s) may use the information provided by the TCI(s) to generate additional information to identify the location. The wireless communication device(s) may continually update the identity of the location based on the TCI(s) and/or other information. The wireless communication device(s) may send, transmit, and/or report the TCI(s) and/or the location to other wireless communication devices(s), the wireless communication node(s), and/or other entities of the wireless communication system. The wireless communication device(s) may utilize the TCI(s) and/or other information to determine mobility information.

The wireless communication device(s) may determine the TCI(s) using information provided and/or indicated by one or more transmissions, such as the SIB (e.g., the SIB1, the SIB2, and/or other SIB s), the synchronization signal(s) (e.g., the PSS/SSS and/or other signals), the PBCH (or other channels), the reference signal(s) (e.g., the CSI-RS, and/or other signals), and/or other signals, channels, messages, and/or transmissions. The wireless communication device(s) may combine the information provided by the one or more transmissions to determine and/or generate the TCI(s). The wireless communication device(s) may utilize the identity of the domain (e.g., cell ID, the service area ID, the PLMN ID, and/or other identifiers) to determine the TCI(s). The wireless communication device(s) may utilize partial and/or complete information provided by the identity of the domain to determine the TCI(s).

In some embodiments, the wireless communication device(s) may use information provided by the SIB to determine the TCI(s). The information provided by the SIB may comprise the identity of the domain, the CI, the TCGI, the CRI, the TCI information, the list of CRIs, the list of TCI information, and/or other information. In some embodiments, the wireless communication device(s) may use information provided by the synchronization signal(s) to determine the TCI(s). The information provided by the synchronization signal(s) may comprise the PCI, and/or other indicators or information. In some embodiments, the wireless communication device(s) may use information provided by the PBCH (or other channels) to determine the TCI(s). The information provided by the PBCH may comprise the MIB, the SSB, the SSBI, and/or other information. In some embodiments, the wireless communication device(s) may use information provided by the reference signals(s). The information provided by the reference signal(s) may comprise information to select a CRI and/or TCI information from a list of CRI and/or a list of TCI information, such as the relationship and/or association between the selected CRI and/or TCI and the reference signal(s).

The wireless communication device(s) may use and/or combine the information provided by the SIB, the synchronization signal(s), the PBCH, and/or the reference signal(s) to determine and/or generate the TCI(s). For example, the wireless communication device(s) may determine the TCI(s) by using the identity of the domain in the SIB(s) and/or additional information in the SIB(s). The wireless communication device(s) may determine the TCI(s) by using the identity of the domain(s) in the SIB(s) and/or the SSBI(s) in the PBCH (or other channels). The wireless communication device(s) may determine the TCI(s) by using the identity of the domain(s) and the TCGI(s) in the SIB(s), and/or the SSBI(s) in the PBCH (or other channels). The wireless communication device(s) may determine the TCI(s) by using the identity of the domain(s) and/or the CRI(s) in the SIB(s), the CRI(s) selected according to the CSI-RS (or other reference signal(s)).

In some embodiments, the wireless communication device(s) may determine the TCI(s) by using the identity of the domain(s) and/or TCI information in the SIB(s), the TCI information selected according to the CSI-RS (or other reference signal(s)). The wireless communication device(s) may determine the TCI(s) by using the identity of the domain(s), the TCGI(s) and/or TCI information in the SIB(s), the TCI information selected according to the CSI-RS (or other reference signal(s)). The wireless communication device(s) may determine the TCI(s) by using the identity of the domain(s), the TCGI(s) and/or the CRI(s) in the SIB(s), the CRI selected according to the CSI-RS (or other reference signal(s)).

In some embodiments, the wireless communication device(s) may determine the TCI(s) by using the identity of the domain(s) and the CRI(s) in the SIB(s), and/or the SSBI(s) in the PBCH (or other channels). The CRI(s) may be selected according to the CSI-RS and/or other reference signals. The wireless communication device(s) may determine the TCI(s) by using information in the SIB(s). The wireless communication device(s) may determine the TCI(s) by using the TCGI(s) in the SIB(s), and/or the SSBI(s) in the PBCH (or other channels). The wireless communication device(s) may determine the TCI(s) by using the TCGI(s) and/or the CRI(s) in the SIB(s), the CRI(s) selected according to the CSI-RS (or other reference signals).

In some embodiments, the wireless communication device(s) may determine the TCI(s) by using the TCGI(s) and/or TCI information in the SIB(s), the TCI information selected according to the CSI-RS (or other reference signals). The wireless communication device(s) may determine the TCI(s) by using the TCGI(s) and the CRI(s) in the SIB(s), and/or the SSBI(s) in the PBCH (or other channels). The CRI(s) may be selected according to the CSI-RS (or other reference signal(s)).

The wireless communication device(s) may report or be caused to report the TCI with at least one of a measurement, a radio link failure, a beam failure, and/or a minimization of drive test (MDT). Responsive to generating and/or determining the TCI(s), the wireless communication device(s) may report or be caused to report the TCI. The wireless communication device(s) may be caused to report, send, broadcast, and/or transmit the TCI(s) by the wireless communication device(s), the wireless communication node(s), and/or other entities. The wireless communication device(s) may be caused to report, send, broadcast, and/or transmit the TCI upon receiving at least one transmission from the wireless communication node(s). For example, the wireless communication device(s) may be caused to report the TCI(s) upon receiving a system information message (e.g., the SIB1 and/or other SIB s) from the wireless communication node(s). The wireless communication device(s) may report or be caused to report complete and/or partial information of the TCI(s). The wireless communication device(s) may report or be caused to report the TCI(s) via one or more transmissions and/or messages. The wireless communication device(s) may report or be caused to report the TCI(s) alongside information that may not be utilized to determine the TCI(s). The wireless communication device(s) may report or be caused to report the TCI(s) to other wireless communication device(s), the wireless communication node(s), and/or other entities of the wireless communication system.

The wireless communication device(s) may report or be caused to report the TCI(s) for location purposes, data analysis, data collection, and/or other purposes or motives. The TCI(s) may be reported, sent, transmitted, and/or broadcast with the measurement(s), the radio link failure(s), the beam failure(s), the MDT(s), and/or other events or messages. For example, the wireless communication device(s) may report the TCI(s) to the wireless communication node(s) with the measurement and/or the MDT. The wireless communication device(s) may be caused to report the TCI(s) by the measurement(s), the radio link failure(s), the beam failure(s), and/or the MDT(s). For example, the radio link failure(s) may cause the wireless communication device(s) to report, send, and/or broadcast the TCI(s).

Referring now to operation (956), and in some embodiments, the wireless communication device may determine or be caused to determine an identity of a domain (e.g., cell ID, service area ID, PLMN ID, and/or other identities). The wireless communication device(s) may determine or be caused to determine the identity of the domain according to at least one of the synchronization signal and/or the SIB. The wireless communication devices(s) may be caused to determine the identity of the domain(s) by the wireless communication device(s), the wireless communication node(s), and/or other entities. The wireless communication device(s) may be caused to determine the identity of the domain upon receiving at least one transmission from the wireless communication node(s). For example, the wireless communication device(s) may be caused to determine a cell ID upon receiving the synchronization signal(s) (e.g., the PSS/SSS, and/or other signals) from the wireless communication node(s). The identity of the domain(s) may comprise a cell ID, a service area ID, a PLMN ID, and/or identifiers. The wireless communication device(s) may determine or be caused to determine the identity of the domain using one or more synchronization signals, the SIBs (e.g., SIB1, SIB2, and/or others SIBs), and/or other information. The wireless communication device(s) may determine or be caused to determine the identity of the domain by using one or more transmissions of the synchronization signal(s) and/or the SIB(s). The wireless communication device(s) may combine the information provided by the synchronization signal(s) and/or the SIB (s) with other information to determine the identity of the domain. Responsive to determining the identity of the domain, the wireless communication device(s) may utilize the identity of the domain(s), the TCI(s), and/or other information to identify a transmission control indication state.

Referring now to operation (958), and in some embodiments, the wireless communication device may identify or be caused to identify a transmission control indication state within the domain. The wireless communication device may identify the transmission control indication states according to the TCI and/or the identity of the domain. Responsive to determining the TCI and/or the identity of the domain, the wireless communication device may identify or be caused to identify one or more transmission control indication states within the domain. The wireless communication device may be caused to identify the transmission control indication state by the wireless communication node(s), and/or other entities. The wireless communication device may be caused to identify the transmission control indication state upon receiving at least one transmission from the wireless communication node(s). For example, the wireless communication device may be caused to identify the transmission control indication state upon receiving information provided by the reference signal(s) (e.g., CSI-RS) from the wireless communication node(s). The transmission control indication state may comprise multiple types of information, such as information related to signal reception attributes (e.g., doppler shift, doppler spread, average delay, delay spread, and/or other spatial parameters). The domain may comprise a cell, a service area, a PLMN, and/or other domains.

The wireless communication device(s) may utilize the TCI(s), the identity of the domain(s), and/or other information to identify or be caused to identify the transmission control indication state(s). The wireless communication device(s) may utilize the complete and/or partial information indicated by the TCI(s) and/or the identity of the domain(s) to identify or be caused to identify the transmission control indication states(s). The wireless communication device(s) may use the TCI(s) and/or the identity of the domain(s) to generate other information to identify or be caused to identify the transmission control indication state(s). The wireless communication device(s) may utilize information from previous and/or other transmission control indication states to identify or be caused to identify the transmission control indication state(s).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
determining, by a wireless communication device, a transmission control indication state identifier (TCI) according to at least one transmission from a wireless communication node;
determining, by the wireless communication device, an identity of a domain; and
identifying, by the wireless communication device according to the TCI and the identity, a transmission control indication state within the domain.

2. The method of claim 1, wherein the at least one transmission comprises at least one of a system information block (SIB), a synchronization signal, a physical broadcast channel (PBCH), or a reference signal (RS).

3. The method of claim 2, comprising determining, by the wireless communication device, the identity of the domain according to at least one of the synchronization signal or the SIB.

4. The method of claim 3, comprising determining, by the wireless communication device, the TCI using the identity of the domain in the SIB and additional information in the SIB.

5. The method of claim 3, comprising determining, by the wireless communication device, the TCI using the identity of the domain in the SIB and a synchronization signal block index (SSBI) in the PBCH.

6. The method of claim 3, comprising determining, by the wireless communication device, the TCI using the identity of the domain and a transmission control indication state group identity (TCGI) in the SIB, and a synchronization signal block index (SSBI) in the PBCH.

7. The method of claim 3, comprising determining, by the wireless communication device, the TCI using the identity of the domain and a CSI-RS resource index (CRI) in the SIB, the CRI selected according to the CSI-RS.

8. The method of claim 3, comprising determining, by the wireless communication device, the TCI using the identity of the domain and TCI information in the SIB, the TCI information selected according to the CSI-RS.

9. The method of claim 3, comprising determining, by the wireless communication device, the TCI using the identity of the domain, a transmission control indication state group identity (TCGI) and TCI information in the SIB, the TCI information selected according to the CSI-RS.

10. The method of claim 3, comprising determining, by the wireless communication device, the TCI using the identity of the domain, a transmission control indication state group identity (TCGI) and a CSI-RS resource index (CRI) in the SIB, the CRI selected according to the CSI-RS.

11. The method of claim 3, comprising determining, by the wireless communication device, the TCI using the identity of the domain and a CSI-RS resource index (CRI) in the SIB, and a synchronization signal block index (SSBI) in the PBCH, the CRI selected according to the CSI-RS.

12. The method of claim 3, comprising determining, by the wireless communication device, the TCI using information in the SIB.

13. The method of claim 3, comprising determining, by the wireless communication device, the TCI using a transmission control indication state group identity (TCGI) in the SIB, and a synchronization signal block index (SSBI) in the PBCH.

14. The method of claim 3, comprising determining, by the wireless communication device, the TCI using a transmission control indication state group identity (TCGI) and a CSI-RS resource index (CRI) in the SIB, the CRI selected according to the CSI-RS.

15. The method of claim 3, comprising determining, by the wireless communication device, the TCI using a transmission control indication state group identity (TCGI) and TCI information in the SIB, the TCI information selected according to the CSI-RS.

16. The method of claim 3, comprising determining, by the wireless communication device, the TCI using a transmission control indication state group identity (TCGI) and a CSI-RS resource index (CRI) in the SIB, a synchronization signal block index (SSBI) in the PBCH, the CRI selected according to the CSI-RS.

17. The method of claim 1, comprising:
identifying, by the wireless communication device using the TCI, a location; or
reporting, by the wireless communication device, the TCI with at least one of: a measurement, a radio link failure, a beam failure, or a minimization of drive test (MDT).

18. A wireless communication device, comprising:
at least one processor configured to:
determine, a transmission control indication state identifier (TCI) according to at least one transmission from a wireless communication node;
determine an identity of a domain; and
identify, according to the TCI and the identity, a transmission control indication state within the domain.

19. A method, comprising:
sending, by a wireless communication node, at least one transmission to a wireless communication device to determine a transmission control indication state identifier (TCI);
causing the wireless communication device to determine an identity of a domain, and to identify, according to the TCI and the identity, a transmission control indication state within the domain.

20. A wireless communication node, comprising:
at least one processor configured to:
send, via a transmitter, at least one transmission to a wireless communication device to determine a transmission control indication state identifier (TCI),
wherein the wireless communication device determines an identity of a domain, and identifies, according to the TCI and the identity, a transmission control indication state within the domain.
